(19) United States
(12) Patent Application Publication
(10) Pub. No.: US 2025/0128157 A1
(43) Pub. Date: Apr. 24, 2025

(54) PROCESSING RELATIONSHIP-BASED AVATAR

(71) Applicant: Tencent Technology (Shenzhen) Company Limited, Shenzhen (CN)

(72) Inventors: Fang GAO, Shenzhen (CN); Wei JIANG, Shenzhen (CN); Jialu ZHANG, Shenzhen (CN); Jun ZHANG, Shenzhen (CN)

(73) Assignee: Tencent Technology (Shenzhen) Company Limited, Shenzhen (CN)

(21) Appl. No.: 19/002,581

(22) Filed: Dec. 26, 2024

Related U.S. Application Data
(63) Continuation of application No. PCT/CN2023/125556, filed on Oct. 20, 2023.

(30) Foreign Application Priority Data
Nov. 28, 2022 (CN) 202211512764.X

(51) Int. Cl. A63F 13/5372; A63F 13/79; A63F 13/87

(52) U.S. Cl. CPC A63F 13/5372; A63F 13/79; A63F 13/87

(57) ABSTRACT

In a method for displaying relationship-based relationship indicators in a gaming interface, a team interface including a plurality of player positions is displayed. Player avatars at the plurality of player positions are displayed. Each player avatar corresponds to a respective team member of a plurality of team members. When a relationship is detected between at least two team members of the plurality of team members, relationship indicators at the plurality of player positions corresponding to the at least two team members are displayed. The relationship indicators indicate the relationship detected between the at least two team members. Apparatus and non-transitory computer-readable storage medium counterpart embodiments are also contemplated.

### RELATED APPLICATIONS

The present application is a continuation of International Application No. PCT/CN2023/125556, filed on Oct. 20, 2023, which claims priority to Chinese Patent Application No. 202211512764.X, filed on Nov. 28, 2022. The entire disclosures of the prior applications are hereby incorporated by reference.

### FIELD OF THE TECHNOLOGY

Embodiments of this disclosure relate to the field of human-computer interaction, including processing a relationship-based avatar.

### BACKGROUND OF THE DISCLOSURE

In various types of games, a quantity of team cooperation games gradually increases. In such a game, players need to form a game team before the game starts and play the game together.

In a waiting period to form the game team before the game starts, the players sometimes communicate with each other to know various information about each other including an intimate relationship, so as to enhance teamwork in the game.

However, the players often need to know a large number of other information when forming the game team, and may miss information such as an intimate relationship. Therefore, an intimate relationship processing method that is not easily ignored by game teammates is required.

### SUMMARY

Embodiments of this disclosure provide an intimate relationship-based avatar processing method, apparatus, and a non-transitory computer-readable storage medium. Examples of technical solutions in the embodiments of this disclosure may be implemented as follows.

An aspect of this disclosure provides a method for displaying relationship-based relationship indicators in a gaming interface. A team interface including a plurality of player positions is displayed. Player avatars at the plurality of player positions are displayed. Each player avatar corresponds to a respective team member of a plurality of team members. When a relationship is detected between at least two team members of the plurality of team members, relationship indicators at the plurality of player positions corresponding to the at least two team members are displayed. The relationship indicators indicate the relationship detected between the at least two team members.

An aspect of this disclosure provides an apparatus. The apparatus includes processing circuitry configured to display a team interface including a plurality of player positions. The processing circuitry is configured to display player avatars at the plurality of player positions, each player avatar corresponding to a respective team member of a plurality of team members. When a relationship is detected between at least two team members of the plurality of team members, the processing circuitry is configured to display relationship indicators at the plurality of player positions corresponding to the at least two team members, wherein the relationship indicators indicate the relationship detected between the at least two team members.

An aspect of this disclosure provides a non-transitory computer-readable storage medium storing instructions which when executed by a processor cause the processor to perform any of the methods of this disclosure.

The technical solutions provided in embodiments of this disclosure can have the following beneficial effects.

In a case that at least two game teammates have an intimate relationship, intimacy avatar information corresponding to the intimate relationship is displayed, so that a game teammate not in the intimate relationship can know information about a game team, and teammate avatars can be dynamically switched to the intimacy avatar information for display. In this way, regions other than the teammate avatars are not occupied, so that display space can be saved, and a probability of an intimate relationship between game teammates being ignored by another game teammate can be reduced.

### BRIEF DESCRIPTION OF THE DRAWINGS

FIG. 1 is a schematic diagram of a computer system according to an embodiment of this disclosure.

FIG. 2 is a schematic diagram of an intimate relationship-based avatar processing method according to an embodiment of this disclosure.

FIG. 3 is a flowchart of an intimate relationship-based avatar processing method according to an embodiment of this disclosure.

FIG. 4 is a flowchart of an intimate relationship-based avatar processing method according to an embodiment of this disclosure.

FIG. 5 is a flowchart of an intimate relationship-based avatar processing method according to an embodiment of this disclosure.

FIG. 6 is a flowchart of an intimate relationship-based avatar processing method according to an embodiment of this disclosure.

FIG. 7 is a flowchart of an intimate relationship-based avatar processing method according to an embodiment of this disclosure.

FIG. 8 is a flowchart of an intimate relationship-based avatar processing method according to an embodiment of this disclosure.

FIG. 9 is a flowchart of an intimate relationship-based avatar processing method according to an embodiment of this disclosure.

FIG. 10 is a flowchart of an intimate relationship-based avatar processing method according to an embodiment of this disclosure.

FIG. 11 is a schematic diagram of an intimate relationship-based avatar processing method according to an embodiment of this disclosure.

FIG. 12 is a schematic diagram of an intimate relationship-based avatar processing method according to an embodiment of this disclosure.

FIG. 13 is a flowchart of an intimate relationship-based avatar processing method according to an embodiment of this disclosure.

FIG. 14 is a schematic diagram of an intimate relationship-based avatar processing method according to an embodiment of this disclosure.

FIG. 15 is a schematic diagram of an intimate relationship-based avatar processing method according to an embodiment of this disclosure.

FIG. 16 is a schematic diagram of an intimate relationship-based avatar processing method according to an embodiment of this disclosure.

FIG. 17 is a block diagram of an intimate relationship-based avatar processing apparatus according to an embodiment of this disclosure.

FIG. 18 is a schematic diagram of a structure of a computer device according to an embodiment of this disclosure.

### DESCRIPTION OF EMBODIMENTS

A brief introduction to some key terms in this disclosure is provided below. The descriptions of the terms are provided as examples only and are not intended to limit the scope of the disclosure.

Waiting-for-start process: It is a process of gathering different players into a game room to form a game team in a game. In the game room, when the players are all present and click/tap start matching, an enemy game team opposing to an ally game team is matched in a game system. The waiting-for-start process is a process from clicking/tapping start matching to successfully matching the enemy game team.

Intimate relationship: It is a virtual relationship established between players in a game, such as a lover relationship, a sisterhood relationship, and a brotherhood relationship.

Former teammate relationship: It is a type of an intimate relationship, and represents a relationship between players who have formed a team together.

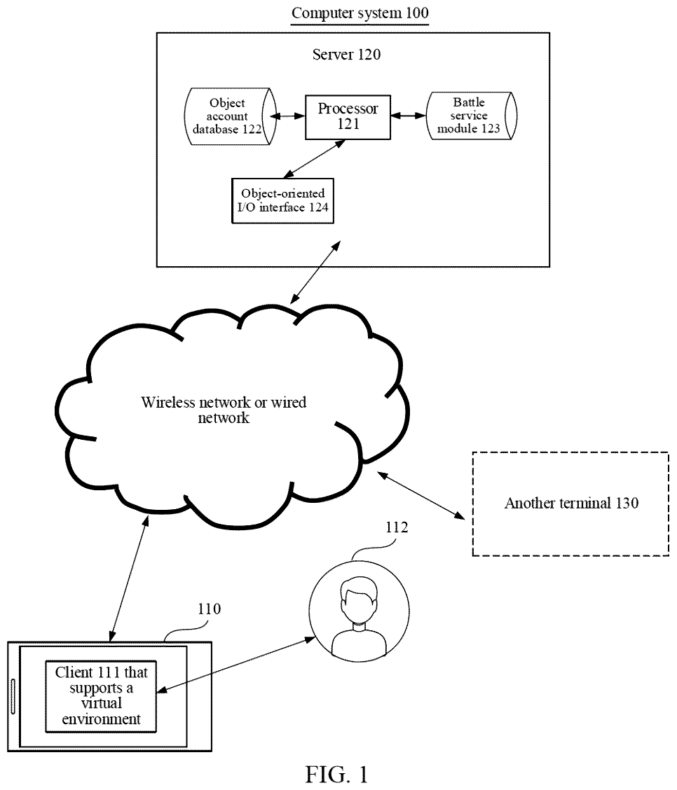

FIG. 1 is a schematic diagram of a computer system 100 according to an embodiment of this disclosure. The computer system 100 includes a terminal 110 and a server 120.

A client 111 that supports a virtual environment is installed and run on the terminal 110. The client 111 may be a multiplayer online battle program. When the terminal 110 runs the client 111, an object interface of the client 111 is displayed on a screen of the terminal 110. The client 111 may be any one of a virtual reality (VR) application, an augmented reality (AR) program, a three-dimensional map program, a virtual reality game, an augmented reality game, a first-person shooting (FPS) game, a third-personal shooting (TPS) game, or a multiplayer online battle arena (MOBA) game. The terminal 110 is a terminal used by a usage object 112. The terminal 110 may be one of a plurality of terminals. The terminal 110 is only used as an example for description in this embodiment. A device type of the terminal 110 includes at least one of a smartphone, a tablet computer, an e-book reader, a portable laptop computer, or a desktop computer.

FIG. 1 only shows one terminal. However, there are a plurality of other terminals 130 that may access the server 120 in different embodiments. In some embodiments, there are alternatively one or more terminals 130 that correspond to a developer. A development and editing platform for a client that supports a virtual environment is installed on the terminal 130. The developer may edit and update the client on the terminal 130, and transmit an updated client installation package to the server 120 via a wired or wireless network. The terminal 110 may download the client installation package from the server 120 to update the client.

The terminal 110 and the other terminals 130 are connected to the server 120 via a wireless network or a wired network.

The server 120 includes at least one of a server, a plurality of servers, a cloud computing platform, or a virtualization center. The server 120 is configured to provide a background service to the client 111. In some embodiments, the server 120 is responsible for primary computing work, and the terminal 110 is responsible for secondary computing work. Alternatively, the server 120 is responsible for secondary computing work, and the terminal 110 is responsible for primary computing work. Alternatively, a distributed computing architecture may be used between the server 120 and the terminal 110 for collaborative computing.

In some embodiments, the server 120 includes a processor 121, an object account database 122, a battle service module 123, and an object-oriented input/output interface (I/O interface) 124. The processor 121 is configured to load instructions stored in the server 120 and process data in the object account database 122 and the battle service module 123. The object account database 122 is configured to store data of object accounts used by the terminal 110 and the other terminals 130, for example, avatars of object accounts, nicknames of the object accounts, combat power indexes of the object accounts, and service zones of the object accounts. The battle service module 123 is configured to provide a plurality of battle rooms for objects to battle, for example, 1V1 battle, 3V3 battle, and 5V5 battle. The object-oriented I/O interface 124 is configured to establish communication with the terminal 110 and/or the other terminals 130 via a wireless network or a wired network for data exchange. In various types of games, a quantity of team cooperation games gradually increases. In such a game, players need to form a game team before the game starts and play the game together. In a waiting period to form the game team before the game starts, the players sometimes communicate with each other to know various information about each other including an intimate relationship, so as to enhance teamwork in the game. However, the players often need to know a large number of other information, and miss information such as an intimate relationship. Therefore, an intimate relationship-based avatar processing method that is not easily ignored by a person is required.

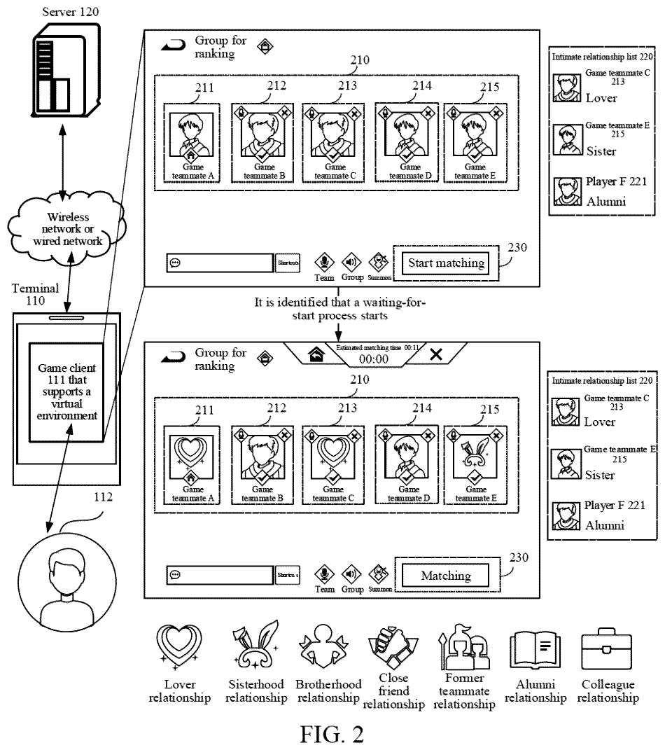

In this disclosure, players in the same game team are referred to as game teammates. An intimate relationship between the game teammates is displayed, so that game teammates not in the intimate relationship can know a group of game teammates with better cooperation in the game team. FIG. 2 is a schematic diagram of an intimate relationship-based avatar processing method according to an embodiment of this disclosure. The method is performed by a terminal 110 and a server 120.

A game client 111 that supports a virtual environment is installed and run on the terminal 110. The game client 111 reads different game parameters on a game interface. The game interface includes at least one of the following: a game team 210 or a matching button 230. An intimate relationship list of game teammates is stored in the server 120. The intimate relationship list of the game teammates is a set of players who have an intimate relationship with the game teammates. In this embodiment, an example in which a usage object 112 controls a virtual game account of a game teammate A and an intimate relationship list 220 is an intimate relationship list of the game teammate A is used for description.

The game team 210 includes at least one game teammate. For example, the game team 210 includes a game teammate A 211, a game teammate B 212, a game teammate C 213, a game teammate D 214, and a game teammate E 215.

The intimate relationship list 220 is a set of players who have an intimate relationship with the game teammate A 211. The intimate relationship includes a plurality of types. For example, the intimate relationship includes at least one of the following: a lover relationship, a sisterhood relationship, a brotherhood relationship, a close friend relationship, a former teammate relationship, an alumni relationship, or a colleague relationship. Different intimate relationships have different corresponding intimacy avatars. An intimacy avatar of the lover relationship is a heart. An intimacy avatar of the sisterhood relationship is bunny ears. An intimacy avatar of a brotherhood relationship is a bust. An intimacy avatar of the close friend relationship is arm wrestling. An intimacy avatar of the former teammate relationship is two soldiers fighting side by side. An intimacy avatar of the alumni relationship is a book. An intimacy avatar of the colleague relationship is a briefcase.

The intimate relationship list 220 includes the game teammate C 213 whose intimate relationship with the game teammate A 211 is a lover relationship, the game teammate E 215 whose intimate relationship with the game teammate A 211 is a sisterhood relationship, and a player F 221 whose intimate relationship with the game teammate A 211 is an alumni relationship.

The matching button 230 is a button configured to match an enemy game team. In a case that the usage object 112 does not press/touch the matching button 230, the matching button 230 is displayed as start matching. In a case that the usage object 112 presses/touches the matching button 230, the server 120 starts to match an enemy game team opposing to the game team 210. A game process proceeds to a waiting-for-start process, and the matching button 230 is displayed as matching.

In a case that the game client 111 identifies that the waiting-for-start process starts, intimacy avatar information corresponding to an intimate relationship is displayed at player positions corresponding to at least two game teammates. For example, after the usage object 112 presses/touches the matching button 230, the matching button 230 is displayed as matching. The game client 111 identifies that the intimate relationship between the game teammate A 211 and the game teammate C 213 is the lover relationship, and the intimate relationship between the game teammate A 211 and the game teammate E 215 is the sisterhood relationship. Because the intimate relationship has a display priority, and a display priority of the lover relationship is higher than a display priority of the sisterhood relationship, heart intimacy avatars corresponding to the lover relationship are displayed at player positions of the game teammate A 211 and the game teammate C 213, and intimacy avatars of bunny ears corresponding to the sisterhood relationship are displayed at a player position of the game teammate E 215. The game teammate B 212 and the game teammate D 214 have no intimate relationship with another game teammate, and in this case, avatars of the game teammate B 212 and the game teammate D 214 keep unchanged.

After display duration of the intimacy avatar information reaches a duration threshold, the intimacy avatar information is restored as the teammate avatars for display at the player positions corresponding to the at least two game teammates. For example, in a case that the duration threshold is two seconds, after the intimacy avatar information is displayed for two seconds, the intimacy avatar information is restored as original teammate avatars for display at the player positions of the game teammate A 211, the game teammate C 213, and the game teammate E 215.

In conclusion, according to the method provided in this embodiment, in a case that at least two game teammates have an intimate relationship, intimacy avatar information corresponding to the intimate relationship is displayed, so that a game teammate not in the intimate relationship can know information about a game team. In addition, during various games, teammate avatars are dynamically switched to original teammate avatars or the intimacy avatar information for display. In this way, regions other than the teammate avatars are not occupied, so that display space can be saved, and a probability of an intimate relationship between game teammates being ignored by another game teammate can be reduced. In addition, according to the method provided in this embodiment, intimacy avatar information corresponding to different intimate relationships is displayed based on a display priority, to represent corresponding intimate relationships between different game teammates, so that a probability of an intimate relationship between game teammates being ignored by another game teammate can be reduced. In addition, according to the method provided in this embodiment, display duration of the intimacy avatar information is limited, to reduce power consumption of the terminal while representing the intimate relationship between the game teammates.

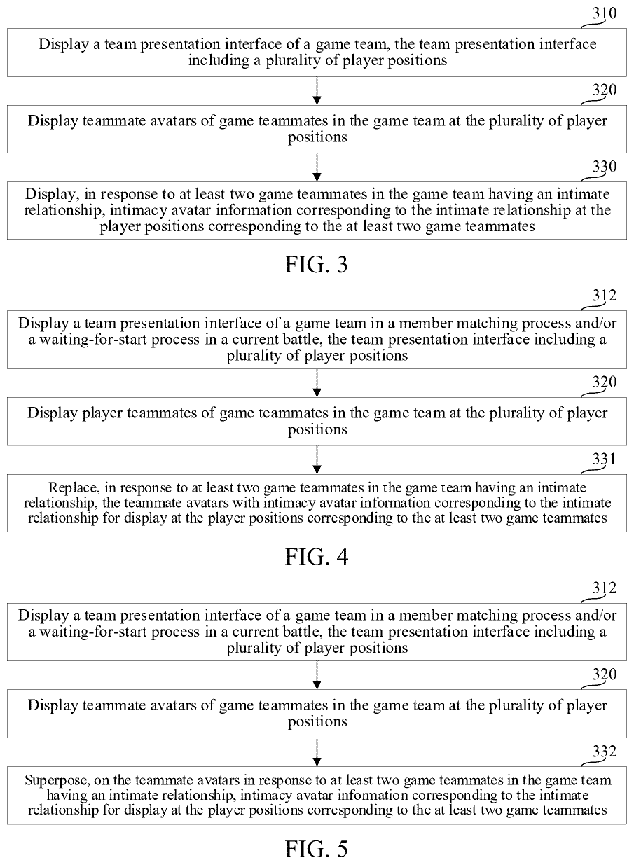

FIG. 3 is a flowchart of an intimate relationship-based avatar processing method according to an embodiment of this disclosure. The method is performed by a terminal and includes the following operations.

Operation 310: Display a team presentation interface of a game team, the team presentation interface including a plurality of player positions. For example, a team interface including a plurality of player positions is displayed.

A team cooperation game is a type of a game that needs players to form a game team before the game starts and work together to complete tasks after the game starts. The terminal displays the team presentation interface of the game team. The team presentation interface includes the plurality of player positions. The player position is configured to provide a display position for at least one of the following information: an identity document (ID) of a game teammate, a teammate avatar, a game level, or other content. A player position state includes an unoccupied state and an occupied state. In a case that no game teammate joins a game team, a player position is in the unoccupied state. In a case that a game teammate joins the game team, player positions corresponding to a quantity of game teammates are in the occupied state.

Operation 320: Display teammate avatars of game teammates in the game team at the plurality of player positions. For example, player avatars at the plurality of player positions are displayed. In an example, each player avatar corresponds to a respective team member of a plurality of team members.

A player position state includes an unoccupied state and an occupied state. In a case that no game teammate joins the game team, the player position is in the unoccupied state, and a blank image is displayed. In a case that a game teammate joins the game team, player positions corresponding to a quantity of game teammates are in the occupied state, teammate avatars corresponding to the game teammates are displayed.

Operation 330: Display, in response to at least two game teammates in the game team having an intimate relationship, intimacy avatar information corresponding to the intimate relationship at the player positions corresponding to the at least two game teammates. For example, when a relationship is detected between at least two team members of the plurality of team members, relationship indicators at the plurality of player positions corresponding to the at least two team members are displayed. The relationship indicators indicate the relationship detected between the at least two team members.

The intimate relationship is a virtual relationship established between different game teammates, including at least one of the following: a lover relationship, a sisterhood relationship, a brotherhood relationship, a close friend relationship, a former teammate relationship, an alumni relationship, or a colleague relationship. For example, the intimate relationship may be created manually based on human-computer interaction, or may be automatically created based on interactive behavior such as a chat between users. Different intimate relationships correspond to different intimacy avatar information. For example, the intimacy avatar information is displayed on a position provided on a player position at which a teammate avatar is displayed, and is image information indicating an intimate relationship in an image form. For example, the intimacy avatar information includes an intimacy avatar and/or an intimacy avatar frame. For example, a display position of the intimacy avatar information and a display position of a teammate avatar of a game teammate provided on a player position have at least one overlapping position point. The intimacy avatar information may be superposed on the teammate avatar in a semi-transparent manner for display, or may cover part or all of the teammate avatar in a non-transparent manner for display.

In a case that the at least two game teammates in the game team have the intimate relationship, the terminal displays intimacy avatars and/or intimacy avatar frames corresponding to the intimate relationship at the player positions corresponding to the at least two game teammates. For example, in a case that an intimate relationship between a game teammate A and a game teammate C is a lover relationship, the terminal displays intimacy avatars and/or intimacy avatar frames corresponding to the lover relationship at player positions corresponding to the game teammate A and the game teammate C.

In conclusion, according to the method provided in this embodiment, in a case that at least two game teammates have an intimate relationship, intimacy avatar information corresponding to the intimate relationship is displayed, so that a game teammate not in the intimate relationship can know information about a game team, and teammate avatars can be dynamically switched to the intimacy avatar information for display. In this way, regions other than the teammate avatars are not occupied, so that display space can be saved, and a probability of an intimate relationship between game teammates being ignored by another game teammate can be reduced.

FIG. 4 is a flowchart of an intimate relationship-based avatar processing method according to an embodiment of this disclosure. The method is performed by a terminal and includes the following operations.

Operation 312: Display a team presentation interface of a game team in a member matching process and/or a waiting-for-start process in a current battle, the team presentation interface including a plurality of player positions. For example, the team interface is displayed before a start of a game.

A game process includes at least one of the following: a member matching process, a waiting-for-start process, a game battle process, or a game settlement process. In the member matching process, a quantity of game teammates in the game team is smaller than a quantity of teammates required to start a game battle, and a game teammate may join and/or leave the game team. In a case that the quantity of game teammates in the game team reaches the quantity of teammates required to start a game battle, the member matching process ends, and the waiting-for-start process starts. The waiting-for-start process is a process from a server started matching an enemy game team to an enemy game team being successfully matched. The waiting-for-start process may alternatively include a waiting process in which resource recording is performed on a virtual environment that provides the game battle. In the member matching process and/or the waiting-for-start process in the current battle, the terminal displays the team presentation interface of the game team. The team presentation interface is configured to display contents such as teammate IDs, teammate avatars, and game levels of the game teammates.

Operation 320: Display teammate avatars of game teammates in the game team at the plurality of player positions. For example, player avatars at the plurality of player positions are displayed. In an example, each player avatar corresponds to a respective team member of a plurality of team members.

For example, a player position state includes an unoccupied state and an occupied state. In an example, the quantity of teammates required to start a game battle may be a quantity range. For example, a quantity of required teammates is three to five. To ensure that a quantity of game teammates in the game team that can be accommodated is five, five player positions are displayed. Further, in a case that the quantity of game teammates in the game team is three, which reaches the quantity of teammates required to start a game battle, the waiting-for-start process may start. In this case, states of some player positions are the unoccupied state in the waiting-for-start process.

Operation 331: Replace, in response to at least two game teammates in the game team having an intimate relationship, the teammate avatars with intimacy avatar information corresponding to the intimate relationship for display at the player positions corresponding to the at least two game teammates. For example, the player avatars are replaced with the relationship indicators avatars at the plurality of player positions corresponding to the at least two team members.

In a case that the at least two game teammates in the game team having the intimate relationship, the terminal replaces the teammate avatars with intimacy avatars and/or intimacy avatar frames corresponding to the intimate relationship for display at the player positions corresponding to the at least two game teammates. The intimacy avatar information includes at least one of the following:
a first intimacy avatar and/or a first intimacy avatar frame corresponding to a lover relationship; a second intimacy avatar and/or a second intimacy avatar frame corresponding to a sisterhood relationship; a third intimacy avatar and/or a third intimacy avatar frame corresponding to a brotherhood relationship; a fourth intimacy avatar and/or a fourth intimacy avatar frame corresponding to a close friend relationship; a fifth intimacy avatar and/or a fifth intimacy avatar frame corresponding to a former teammate relationship; a sixth intimacy avatar and/or a sixth intimacy avatar frame corresponding to an alumni relationship; or a seventh intimacy avatar and/or a seventh intimacy avatar frame corresponding to a colleague relationship.

In some embodiments, the intimate relationship is established by the game teammates before the current battle. For example, an intimate relationship established between a game teammate A and a game teammate C is a lover relationship before the current battle. In this case, the terminal replaces teammate avatars of the game teammate A and the game teammate C with first intimacy avatars and/or first intimacy avatar frames corresponding to the lover relationship for display at player positions corresponding to the game teammate A and the game teammate C.

In some embodiments, the intimate relationship is identified by the server based on personalized information of the game teammates, and the server identifies and obtains the intimate relationship in at least one of the following manners under authorization for using the personalized information. The personalized information is obtained under full user authorization after prompting a user in at least one of manners such as a user privacy protocol, a pop-up window prompt, or the like. In an implementation, the user is prompted each time during the obtaining of information for obtaining individual consent of the user. A person skilled in the art may understand that the information is obtained only for identifying the intimate relationship under the individual consent of the user. In an implementation, when a request for obtaining the information is made to the user, use of the information is displayed. Obtaining the use of the information is not beyond the consent of the user, and the information is not uploaded, stored, or disclosed without the full user authorization.

1. Obtain a game dialog record between the game teammates, and identify an appellation keyword from the game dialog record; and identify the intimate relationship between the game teammates based on the appellation keyword. For example, appellation keywords, husband and wife, are identified in a game dialog record between two game teammates, and an intimate relationship between the two game teammates is identified as a lover relationship based on the appellation keywords. In this case, the terminal replaces teammate avatars of the two game teammates with first intimacy avatars and/or first intimacy avatar frames corresponding to the lover relationship for display at player positions corresponding to the two game teammates.

2. Obtain personal attribute information of the game teammates, and identify same experience information from the personal attribute information; and identify the intimate relationship between the game teammates based on the same experience information. For example, it is identified from personal attribute information of two game teammates that the two game teammates graduate from the same school, and an intimate relationship between the two game teammates is identified as an alumni relationship based on the same graduation school. In this case, the terminal replaces teammate avatars of the two game teammates with sixth intimacy avatars and/or sixth intimacy avatar frames corresponding to the alumni relationship for display at player positions corresponding to the two game teammates.

3. Obtain current geographical location information of the game teammates, and identify a same enterprise and institution location from the geographical location information; and identify the intimate relationship between the game teammates based on the same enterprise and institution location. For example, if two game teammates work in the same enterprise, an intimate relationship between the two game teammates is identified as a colleague relationship based on the same enterprise and institution location. In this case, the terminal replaces teammate avatars of the two game teammates with seventh intimacy avatars and/or seventh intimacy avatar frames corresponding to the colleague relationship for display at player positions corresponding to the two game teammates.

In conclusion, according to the method provided in this embodiment, in a member matching process and/or a waiting-for-start process of a game, in a case that at least two game teammates have an intimate relationship, intimacy avatar information corresponding to the intimate relationship is displayed, so that a game teammate not in the intimate relationship can know information about a game team, and teammate avatars are dynamically switched to the intimacy avatar information for display. In this way, regions other than the teammate avatars are not occupied, so that display space can be saved, and a probability of an intimate relationship between game teammates being ignored by another game teammate can be reduced.

FIG. 5 is a flowchart of an intimate relationship-based avatar processing method according to an embodiment of this disclosure. The method is performed by a terminal and includes the following operations.

Operation 312: Display a team presentation interface of a game team in a member matching process and/or a waiting-for-start process in a current battle, the team presentation interface including a plurality of player positions. For example, the team interface is displayed before a start of a game.

Operation 320: Display teammate avatars of game teammates in the game team at the plurality of player positions. For example, player avatars at the plurality of player positions are displayed. In an example, each player avatar corresponds to a respective team member of a plurality of team members.

For descriptions of operation 312 and operation 320, reference is made to the foregoing descriptions in the embodiment corresponding to FIG. 4, which are not described herein again.

Operation 332: Superpose, on the teammate avatars in response to at least two game teammates in the game team having an intimate relationship, intimacy avatar information corresponding to the intimate relationship for display at the player positions corresponding to the at least two game teammates. For example, the relationship indicators are overlayed on top of the player avatars at the plurality of player positions corresponding to the at least two team members.

In a case that the at least two game teammates in the game team having the intimate relationship, the terminal does not replace original teammate avatars at the player positions corresponding to the at least two game teammates, but superposes, on the teammate avatars, intimacy avatars and/or intimacy avatar frames corresponding to the intimate relationship for display.

For example, in a case that an intimate relationship between a game teammate A and a game teammate C is a lover relationship, the terminal superposes, on teammate avatars of the game teammate A and the game teammate C, intimacy avatars and/or intimacy avatar frames corresponding to the lover relationship for display at player positions corresponding to the game teammate A and the game teammate C.

In some embodiments, display states of intimacy avatars in different groups of game teammates with the same intimate relationship are different. For example, an intimate relationship between a game teammate A and a game teammate C is a lover relationship, and an intimate relationship between a game teammate B and a game teammate D is also a lover relationship. There is a connected line between the intimacy avatars of the game teammate A and the game teammate C, and there is another connected line between intimacy avatars of the game teammate B and the game teammate D.

In some embodiments, a display state of an intimacy avatar is related to an intimacy level of an intimate relationship. The intimacy level is a value for representing an intimacy degree between game teammates who have an intimate relationship and is an integer. For example, the intimacy avatar is displayed as a sign of a first stage in a case that the intimacy level is 100. For example, an intimacy avatar of a lover relationship with an intimacy level of 100 is displayed as a heart. The intimacy avatar is displayed as a sign of a second stage in a case that the intimacy level is 500. For example, an intimacy avatar of a lover relationship with an intimacy level of 500 is displayed as a plurality of hearts. Alternatively, the intimacy avatar is a static avatar with no movement in a case that the intimacy level is 100. For example, an intimacy avatar of a sisterhood relationship with an intimacy level of 100 is displayed as static bunny ears. The intimacy avatar is a dynamic avatar with movement in a case that the intimacy level is 500. For example, an intimacy avatar of a sisterhood relationship with an intimacy level of 500 is displayed as dynamic bunny ears that may sway.

In conclusion, according to the method provided in this embodiment, in a member matching process and/or a waiting-for-start process of a game, in a case that at least two game teammates have an intimate relationship, intimacy avatar information corresponding to the intimate relationship is superposed on teammate avatars for display at player positions corresponding to the at least two game teammates. In this way, in different game processes, an intimate relationship between game teammates can be represented without additional communication, so that a game teammate not in the intimate relationship can know information about a game team, thereby reducing a probability of an intimate relationship between game teammates being ignored by another game teammate.

In addition, according to the method provided in this embodiment, display states of intimacy avatars in different groups of game teammates with the same intimate relationship are different, and a display state of an intimacy avatar is associated with an intimacy level of the intimate relationship, so that concentration of the game teammates on the intimate relationship can be increased, thereby reducing a probability of an intimate relationship between game teammates being ignored by another game teammate.

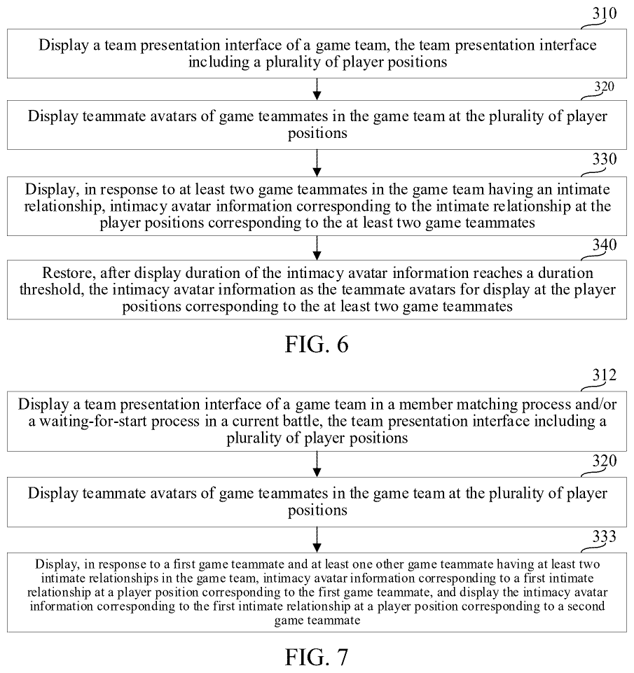

FIG. 6 is a flowchart of an intimate relationship-based avatar processing method according to an embodiment of this disclosure. The method is performed by a terminal and includes the following operations.

Operation 310: Display a team presentation interface of a game team, the team presentation interface including a plurality of player positions. For example, a team interface including a plurality of player positions is displayed.

Operation 320: Display teammate avatars of game teammates in the game team at the plurality of player positions. For example, player avatars at the plurality of player positions are displayed. In an example, each player avatar corresponds to a respective team member of a plurality of team members.

Operation 330: Display, in response to at least two game teammates in the game team having an intimate relationship, intimacy avatar information corresponding to the intimate relationship at the player positions corresponding to the at least two game teammates. For example, when a relationship is detected between at least two team members of the plurality of team members, relationship indicators at the plurality of player positions corresponding to the at least two team members are displayed. In an example, the relationship indicators indicate the relationship detected between the at least two team members.

For descriptions of operation 310 to operation 330, reference is made to the foregoing descriptions in the embodiment corresponding to FIG. 3, which are not described herein again.

Operation 340: Restore, after display duration of the intimacy avatar information reaches a duration threshold, the intimacy avatar information as the teammate avatars for display at the player positions corresponding to the at least two game teammates. For example, the relationship indicators for a display duration are displayed. After the display duration reaches a duration threshold, the display of the relationship indicators is cancelled. The player avatars are displayed. In an example, the duration threshold is based on a relationship level between the at least two team members.

The intimacy avatar information has the display duration. After the display duration reaches the duration threshold, the terminal does not continue displaying the intimacy avatar information at the player positions corresponding to the at least two game teammates, but restores the intimacy avatar information as the teammate avatars for display. The duration threshold is a fixed value, or the duration threshold is positively correlated with an intimacy level of the intimate relationship. The intimacy level is a value for representing an intimacy degree between game teammates who have an intimate relationship and is an integer.

For example, in a case that the duration threshold is a fixed value of three seconds, after the intimacy avatar information is displayed for three seconds, the terminal restores the intimacy avatar information as the teammate avatars for display.

In a case that the duration threshold is positively correlated with the intimacy level of the intimate relationship, a duration threshold corresponding to an intimate relationship with an intimacy level of 100 is three seconds, and a duration threshold corresponding to an intimate relationship with an intimacy level of 500 is six seconds. After the intimacy avatar information corresponding to the intimate relationship with the intimacy level of 500 is displayed for six seconds, the terminal restores the intimacy avatar information as the teammate avatars for display.

In some embodiments, the display duration of the intimacy avatar information is not fixed, and the terminal does not restore the intimacy avatar information as the teammate avatars for display. For example, in a waiting-for-start process, the intimacy avatar information continues to be displayed, and the terminal does not restore the intimacy avatar information as the teammate avatars for display. The terminal does not display content in the team presentation interface until the waiting-for-start process ends.

In conclusion, according to the method provided in this embodiment, display duration of intimacy avatar information is limited to a fixed value or a value related to an intimacy level of an intimate relationship, to reduce power consumption of the terminal while representing an intimate relationship between game teammates.

In addition, according to the method provided in this embodiment, the display duration of the intimacy avatar information is not limited, so that a game teammate not in the intimate relationship can know the intimate relationship between the game teammates at any time, thereby reducing a probability of an intimate relationship between game teammates being ignored by another game teammate.

FIG. 7 is a flowchart of an intimate relationship-based avatar processing method according to an embodiment of this disclosure. The method is performed by a terminal and includes the following operations.

Operation 312: Display a team presentation interface of a game team in a member matching process and/or a waiting-for-start process in a current battle, the team presentation interface including a plurality of player positions. For example, the team interface is displayed before a start of a game.

Operation 320: Display teammate avatars of game teammates in the game team at the plurality of player positions. For example, player avatars at the plurality of player positions are displayed. In an example, each player avatar corresponds to a respective team member of a plurality of team members.

For descriptions of operation 312 and operation 320, reference is made to the foregoing descriptions in the embodiment corresponding to FIG. 4, which are not described herein again.

Operation 333: Display, in response to a first game teammate and at least one other game teammate having at least two intimate relationships in the game team, intimacy avatar information corresponding to a first intimate relationship at a player position corresponding to the first game teammate, and display the intimacy avatar information corresponding to the first intimate relationship at a player position corresponding to a second game teammate. For example, when a first team member of the plurality of team members has multiple relationships, the relationship indicator corresponding to a highest priority relationship of the multiple relationships is displayed at the plurality of player positions of both the first team member and a second team member of the plurality of team members sharing the highest priority relationship.

The first intimate relationship is an intimate relationship with a high display priority in the at least two intimate relationships, and the second game teammate and the first game teammate have the first intimate relationship. For example, a game teammate A and a game teammate C have a lover relationship and an alumni relationship, and a display priority of the lover relationship is higher than a display priority of the alumni relationship. The terminal displays intimacy avatar information corresponding to the lover relationship at a player position corresponding to the game teammate A, and displays the intimacy avatar information corresponding to the lover relationship at a player position corresponding to the game teammate C.

In conclusion, according to the method provided in this embodiment, only intimacy avatar information corresponding to an intimate relationship that has a high display priority and that is between game teammates is displayed, to reduce power consumption of the terminal while representing an intimate relationship between the game teammates without additional communication, so that a game teammate not in the intimate relationship can know information about a game team. In this way, regions other than teammate avatars are not occupied, so that display space can be saved, and a probability of an intimate relationship between game teammates being ignored by another game teammate can be reduced.

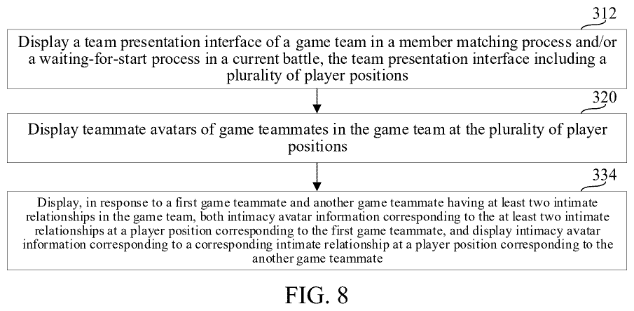

FIG. 8 is a flowchart of an intimate relationship-based avatar processing method according to an embodiment of this disclosure. The method is performed by a terminal and includes the following operations.

Operation 312: Display a team presentation interface of a game team in a member matching process and/or a waiting-for-start process in a current battle, the team presentation interface including a plurality of player positions. For example, the team interface is displayed before a start of a game.

Operation 320: Display teammate avatars of game teammates in the game team at the plurality of player positions. For example, player avatars at the plurality of player positions are displayed. In an example, each player avatar corresponds to a respective team member of a plurality of team members.

For descriptions of operation 312 and operation 320, reference is made to the foregoing descriptions in the embodiment corresponding to FIG. 4, which are not described herein again.

Operation 334: Display, in response to a first game teammate and another game teammate having at least two intimate relationships in the game team, both intimacy avatar information corresponding to the at least two intimate relationships at a player position corresponding to the first game teammate, and display intimacy avatar information corresponding to a corresponding intimate relationship at a player position corresponding to the another game teammate. For example, when a first team member has multiple relationships, multiple relationship indicators are simultaneously displayed at the plurality of player positions of the first team member while displaying corresponding single relationship indicators at the plurality of player positions of the plurality of team members sharing respective relationships of the multiple relationships with the first team member.

The corresponding intimate relationship is an intimate relationship between the first game teammate and the another game teammate. For example, a game teammate A is in a lover relationship with a game teammate C, and is in a sisterhood relationship with a game teammate E. The terminal displays both intimacy avatar information corresponding to the lover relationship and the sisterhood relationship at a player position corresponding to the game teammate A, displays the intimacy avatar information corresponding to the lover relationship, at a player position corresponding to the game teammate C, and displays the intimacy avatar information corresponding to the sisterhood relationship at a player position corresponding to the game teammate E.

In conclusion, according to the method provided in this embodiment, intimacy avatar information corresponding to all intimate relationships between game teammates is displayed simultaneously, to represent corresponding intimate relationships between different game teammates, so that an intimate relationship between the game teammates can be represented without additional communication, and a game teammate not in the intimate relationship can know information about a game team. In this way, regions other than teammate avatars are not occupied, so that display space can be saved, and a probability of an intimate relationship between game teammates being ignored by another game teammate can be reduced.

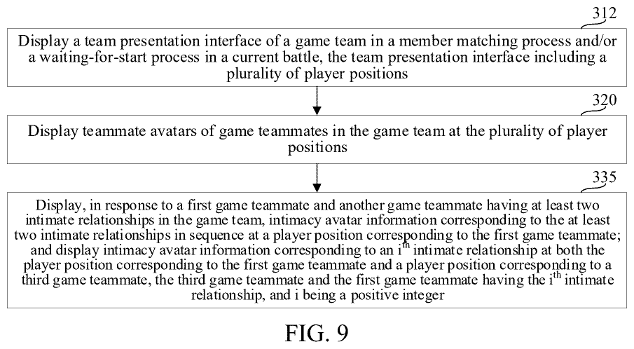

FIG. 9 is a flowchart of an intimate relationship-based avatar processing method according to an embodiment of this disclosure. The method is performed by a terminal and includes the following operations.

Operation 312: Display a team presentation interface of a game team in a member matching process and/or a waiting-for-start process in a current battle, the team presentation interface including a plurality of player positions. For example, the team interface is displayed before a start of a game.

Operation 320: Display teammate avatars of game teammates in the game team at the plurality of player positions. For example, player avatars at the plurality of player positions are displayed. In an example, each player avatar corresponds to a respective team member of a plurality of team members.

For descriptions of operation 312 and operation 320, reference is made to the foregoing descriptions in the embodiment corresponding to FIG. 4, which are not described herein again.

Operation 335: Display, in response to a first game teammate and another game teammate having at least two intimate relationships in the game team, intimacy avatar information corresponding to the at least two intimate relationships in sequence at a player position corresponding to the first game teammate; and display intimacy avatar information corresponding to an i^{th} intimate relationship at both the player position corresponding to the first game teammate and a player position corresponding to a third game teammate, the third game teammate and the first game teammate having the i^{th} intimate relationship, and i being a positive integer. For example, multiple relationship indicators are sequentially displayed at a player position of the plurality of player positions corresponding to a first team member of the plurality of team members having multiple relationships. For each relationship indicator of the multiple relationship indicators, the respective relationship indicator is synchronously displayed at the plurality of player positions corresponding to both the first team member and second team members of the plurality of team members sharing the respective relationship corresponding to the respective relationship indicator.

In a case that the first game teammate and at least one other game teammate have at least two intimate relationships, the terminal displays intimacy avatar information corresponding to an intimate relationship at both the player position corresponding to the first game teammate and the player position corresponding to the third game teammate having the same intimate relationship.

For example, the terminal displays intimacy avatar information corresponding to a lover relationship and a sisterhood relationship in sequence at a player position corresponding to a game teammate A. The terminal displays the intimacy avatar information corresponding to the lover relationship at both the player position corresponding to the game teammate A and a player position corresponding to a game teammate C. The game teammate A and the game teammate C have the lover relationship. The terminal displays the intimacy avatar information corresponding to the sisterhood relationship at both the player position corresponding to the game teammate A and a player position corresponding to a game teammate E. The game teammate A and the game teammate E have the sisterhood relationship.

In conclusion, according to the method provided in this embodiment, intimacy avatar information corresponding to an intimate relationship is displayed at both a player position corresponding to a first game teammate and a player position corresponding to a third game teammate having the same intimate relationship, to represent corresponding intimate relationships between different game teammates, so that an intimate relationship between game teammates can be represented without additional communication, and a game teammate not in the intimate relationship can know information about a game team. In this way, regions other than teammate avatars are not occupied, so that display space can be saved, and a probability of an intimate relationship between game teammates being ignored by another game teammate can be reduced.

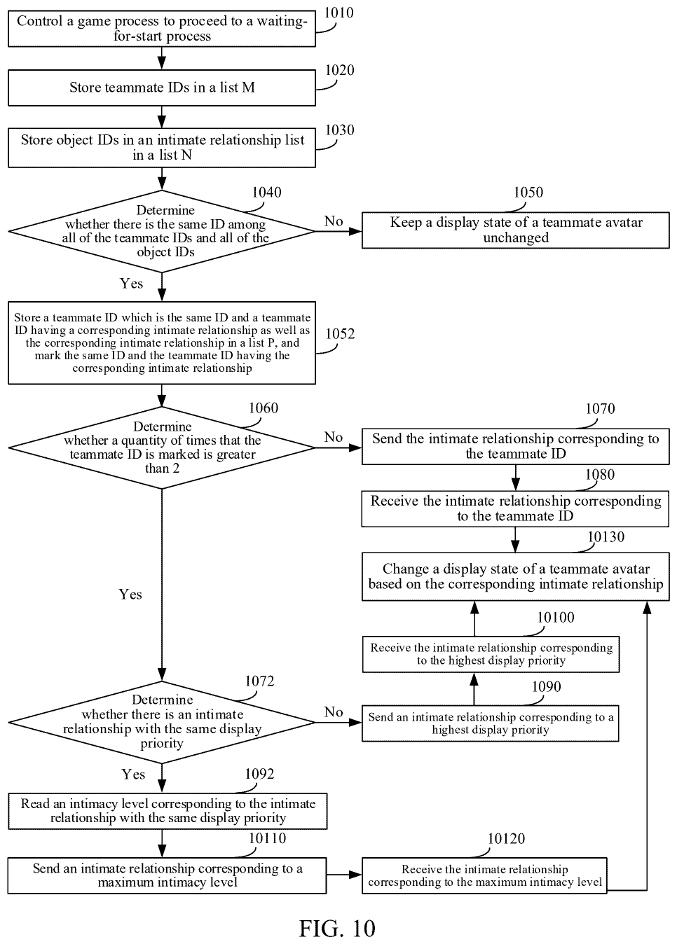

FIG. 10 is a flowchart of an intimate relationship-based avatar processing method according to an embodiment of this disclosure. The method is performed by a terminal and a server and includes the following operations.

Operation 1010: The terminal controls a game process to proceed to a waiting-for-start process.

A game process includes at least one of the following: a member matching process, a waiting-for-start process, a game battle process, or a game settlement process. The terminal controls the game process to proceed to the waiting-for-start process after the member matching process ends. The waiting-for-start process is a process from the server started matching an enemy game team to an enemy game team being successfully matched.

For example, as shown in FIG. 2, a usage object 112 clicks/taps a matching button 230. A terminal 110 controls a game process to proceed to a waiting-for-start process, and the matching button 230 is displayed as matching.

Operation 1020: The server stores teammate IDs in a list M.

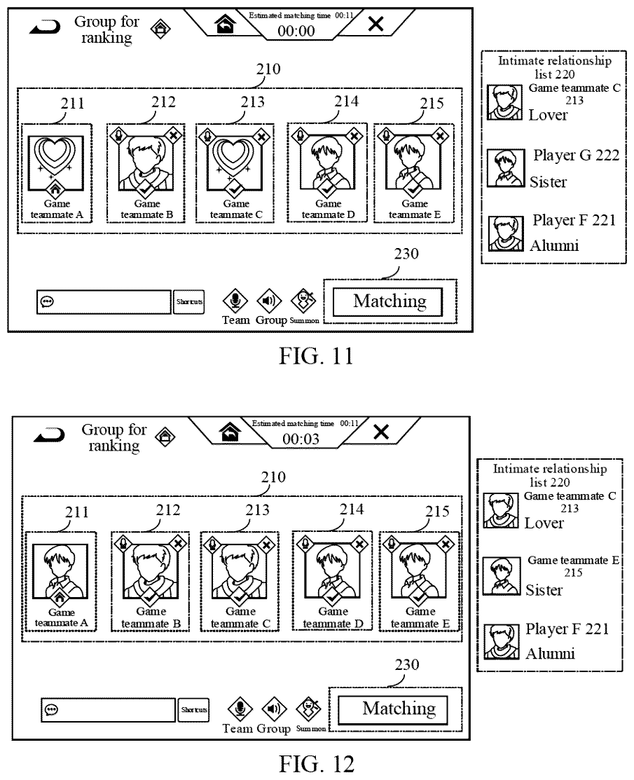

The server stores all of the teammate IDs of a game team in the list M. For example, FIG. 11 is a schematic diagram of an intimate relationship-based avatar processing method according to an embodiment of this disclosure. All of the teammate IDs of the game team include: a game teammate A 211, a game teammate B 212, a game teammate C 213, a game teammate D 214, and a game teammate E 215. The server stores the teammate IDs in the list M.

Operation 1030: The server stores object IDs in an intimate relationship list in a list N.

The server stores the object IDs in intimate relationship lists of all of game teammates in the game team in the list N, and retains non-repeated object IDs. An intimate relationship list of a game teammate is a set of players who have an intimate relationship with the game teammate. The intimate relationship includes a plurality of types. For example, the intimate relationship includes at least one of the following: a lover relationship, a sisterhood relationship, a brotherhood relationship, a close friend relationship, a former teammate relationship, an alumni relationship, or a colleague relationship. As shown in FIG. 11, object IDs in an intimate relationship list of the game teammate A 211 include: the game teammate C 213 whose intimate relationship is a lover relationship, a player G 222 whose intimate relationship is a sisterhood relationship, and a player F 221 whose intimate relationship is an alumni relationship. The server stores the object IDs in the list N.

Operation 1040: The server determines whether there is the same ID among all of the teammate IDs and all of the object IDs.

The server compares all of the teammate IDs with all of the object IDs to determine whether there is the same ID. If there is no same ID, operation 1050 is performed. If there is the same ID, operation 1052 is performed.

Operation 1050: The terminal keeps a display state of a teammate avatar unchanged.

In a case that there is no same ID, the terminal does not perform processing on the display state of the teammate avatar, and keeps the display state of the teammate avatar unchanged.

Operation 1052: The server stores a teammate ID which is the same ID and a teammate ID having a corresponding intimate relationship as well as the corresponding intimate relationship in a list P, and marks the same ID and the teammate ID having the corresponding intimate relationship.

For example, as shown in FIG. 11, the game teammate C 213 in the game team has the same ID as that of the game teammate C 213 in the intimate relationship list of the game teammate A 211. The server stores the game teammate A 211 and the game teammate C 213 as well as the intimate relationship between the game teammate A 211 and the game teammate C 213 being the lover relationship in the list P, and marks the game teammate A 211 and the game teammate C 213.

Because the intimate relationship is a mutual relationship, the game teammate A 211 is also in an intimate relationship list of the game teammate C 213. In this case, after traversing the teammate IDs and the object IDs in the intimate relationship list, the server marks the game teammate A 211 and the game teammate C 213 twice.

Operation 1060: The server determines whether a quantity of times that the teammate ID is marked is greater than 2.

Because the intimate relationship is a mutual relationship, the quantity of times that the teammate ID having the intimate relationship is marked is at least 2. In a case that the quantity of times that the teammate ID is marked is equal to 2, operation 1070 is performed. In a case that the quantity of times that the teammate ID is marked is greater than 2, operation 1072 is performed.

For example, as shown in FIG. 2, the intimate relationship between the game teammate A 211 and the game teammate C 213 is the lover relationship, and the intimate relationship between the game teammate A 211 and the game teammate E 215 is the sisterhood relationship. A quantity of times that the game teammate A 211 is marked is 3, and a quantity of times that the game teammate C 213 and the game teammate E 215 are marked is 2.

Operation 1070: The server sends the intimate relationship corresponding to the teammate ID to the terminal.

In a case that the quantity of times that the teammate ID is marked is equal to 2, for example, as shown in FIG. 2, the server sends to the terminal that the intimate relationship between the game teammate C 213 and the game teammate A 211 is the lover relationship and that the intimate relationship between the game teammate E 215 and the game teammate A 211 is the sisterhood relationship.

Operation 1072: The server determines whether there is an intimate relationship with the same display priority.

The intimate relationship includes a plurality of types, and has a display priority. For example, the intimate relationship includes at least one of the following: a lover relationship, a sisterhood relationship, a brotherhood relationship, a close friend relationship, a former teammate relationship, an alumni relationship, or a colleague relationship. A display priority of the lover relationship is higher than a display priority of the sisterhood relationship. The display priority of the sisterhood relationship is equal to a display priority of the brotherhood relationship and a display priority of the close friend relationship. The display priority of the close friend relationship is higher than a display priority of the former teammate relationship. The display priority of the former teammate relationship is higher than a display priority of the alumni relationship. The display priority of the alumni relationship is equal to a display priority of the colleague relationship.

In a case that there is no intimate relationship with the same display priority, operation 1090 is performed.

In a case that there is an intimate relationship with the same display priority, operation 1092 is performed.

Operation 1080: The terminal receives the intimate relationship corresponding to the teammate ID.

After receiving the intimate relationship that corresponds to the teammate ID and that is sent by the server, in a case of successful reception, the terminal feeds back an acknowledged message to the server, and the server completes a sending task. In case of unsuccessful reception, the terminal feeds back an unacknowledged message to the server, and the server resends the intimate relationship corresponding to the teammate ID.

Operation 1090: The server sends an intimate relationship corresponding to a highest display priority to the terminal.

In a case that there is no intimate relationship with the same display priority, the server sends the intimate relationship corresponding to the highest display priority to the terminal. For example, as shown in FIG. 2, the intimate relationship between the game teammate A 211 and the game teammate C 213 is the lover relationship, and the intimate relationship between the game teammate A 211 and the game teammate E 215 is the sisterhood relationship. There is no intimate relationship with the same display priority between the game teammates, and the display priority of the lover relationship is higher than the display priority of the sisterhood relationship. In this case, the server sends to the terminal that the intimate relationship between the game teammate A 211 and the game teammate C 213 is the lover relationship.

Operation 1092: The server reads an intimacy level corresponding to the intimate relationship with the same display priority.

The intimacy level is a value for representing an intimacy degree between game teammates who have an intimate relationship and is an integer. For example, an intimate relationship between the game teammate B and the game teammate D is an alumni relationship and a colleague relationship. An intimacy level of the alumni relationship is 500, and an intimacy level of the colleague relationship is 100.

Operation 10100: The terminal receives the intimate relationship corresponding to the highest display priority.

After receiving the intimate relationship that corresponds to the highest display priority and that is sent by the server, in a case of successful reception, the terminal feeds back an acknowledged message to the server, and the server completes a sending task. In case of unsuccessful reception, the terminal feeds back an unacknowledged message to the server, and the server resends the intimate relationship corresponding to the highest display priority.

Operation 10110: The server sends an intimate relationship corresponding to a maximum intimacy level to the terminal.

For example, the intimate relationship between the game teammate B and the game teammate D is the alumni relationship and the colleague relationship. The intimacy level of the alumni relationship is 100, and the intimacy level of the colleague relationship is 500 and is higher than the intimacy level of the colleague relationship. In this case, the server sends to the terminal that the intimate relationship between the game teammate B and the game teammate D is the alumni relationship.

Operation 10120: The terminal receives the intimate relationship corresponding to the maximum intimacy level.

After receiving the intimate relationship that corresponds to the maximum intimacy level and that is sent by the server, in a case of successful reception, the terminal feeds back an acknowledged message to the server, and the server completes a sending task. In case of unsuccessful reception, the terminal feeds back an unacknowledged message to the server, and the server resends the intimate relationship corresponding to the maximum intimacy level.

Operation 10130: The terminal changes a display state of a teammate avatar based on the corresponding intimate relationship.

The terminal replaces, based on the corresponding intimate relationship, the teammate avatars with intimacy avatars corresponding to different intimate relationships for display. For example, as shown in FIG. 2, the intimate relationship between the game teammate A 211 and the game teammate C 213 is the lover relationship, and the intimate relationship between the game teammate A 211 and the game teammate E 215 is the sisterhood relationship. The display priority of the lover relationship is higher than that of the sisterhood relationship. In this case, the terminal replaces the avatars of the game teammate A 211 and the game teammate C 213 with heart intimacy avatars representing the lover relationship for display, and replaces an avatar of the game teammate E 215 with a bunny-ear intimacy avatar representing the sisterhood relationship for display.

In some embodiments, the terminal replaces the teammate avatars with a same type of intimacy avatars for display. For example, as shown in FIG. 2, the terminal replaces the avatars of the game teammate A 211 and the game teammate C 213 with the heart intimacy avatars representing the lover relationship for display, and replaces the avatar of the game teammate E 215 with the bunny-ear intimacy avatar representing the sisterhood relationship for display.

Alternatively, the terminal replaces the teammate avatars with a plurality of intimacy avatars for display. For example, the terminal replaces the avatar of the game teammate A 211 with the heart intimacy avatar representing the lover relationship and with the bunny-ear intimacy avatar representing the sisterhood relationship for display, replaces the avatar of the game teammate C 213 with the heart intimacy avatar representing the lover relationship for display, and replaces the avatar of the game teammate E 215 with the bunny-ear intimacy avatar representing the sisterhood relationship for display.

In some embodiments, after display duration of the intimacy avatars reaches a duration threshold, the terminal restores the intimacy avatars as the teammate avatars for display. For example, FIG. 12 is a schematic diagram of an intimate relationship-based avatar processing method according to an embodiment of this disclosure. The duration threshold is two seconds. After the intimacy avatars are displayed for two seconds, the terminal restores the intimacy avatars as the teammate avatars for display.

Alternatively, the intimacy avatars continue to be displayed until the waiting-for-start process ends. For example, duration of the waiting-for-start process is 11 seconds, during which the intimacy avatars continue to be displayed and do not disappear.

In conclusion, according to the method provided in this embodiment, in a waiting-for-start process, teammate IDs are compared with object IDs in an intimate relationship list, to determine a game teammate having an intimate relationship and display intimacy avatar information corresponding to the intimate relationship. In this way, an intimate relationship between game teammates can be represented without additional communication, so that a game teammate not in the intimate relationship can know information about a game team. In this way, regions other than teammate avatars are not occupied, so that display space can be saved, and a probability of an intimate relationship between game teammates being ignored by another game teammate can be reduced.

In addition, according to the method provided in this embodiment, intimacy avatar information corresponding to different intimate relationships is displayed based on a display priority and an intimacy level, to represent corresponding intimate relationships between different game teammates, so that a probability of an intimate relationship between game teammates and being ignored by another game teammate can be reduced. In addition, according to the method provided in this embodiment, display duration of the intimacy avatar information is limited, to reduce power consumption of the terminal while representing the intimate relationship between the game teammates. In addition, according to the method provided in this embodiment, the display duration of the intimacy avatar information is not limited, so that a game teammate not in the intimate relationship can know the intimate relationship between the game teammates at any time, thereby reducing a probability of an intimate relationship between game teammates being ignored by another game teammate.

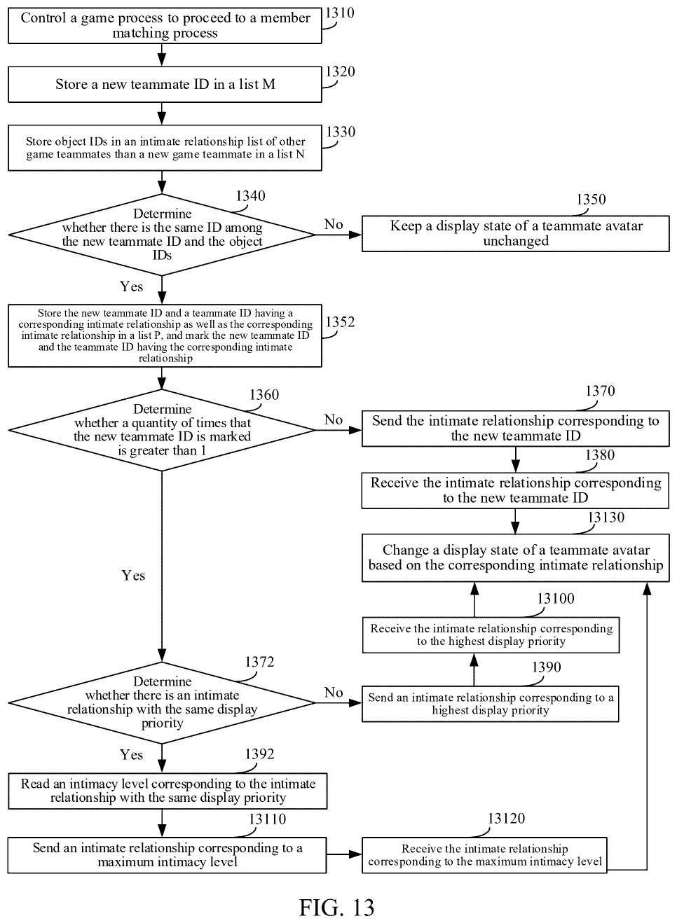

FIG. 13 is a flowchart of an intimate relationship-based avatar processing method according to an embodiment of this disclosure. The method is performed by a terminal and a server and includes the following operations.

Operation 1310: The terminal controls a game process to proceed to a member matching process.

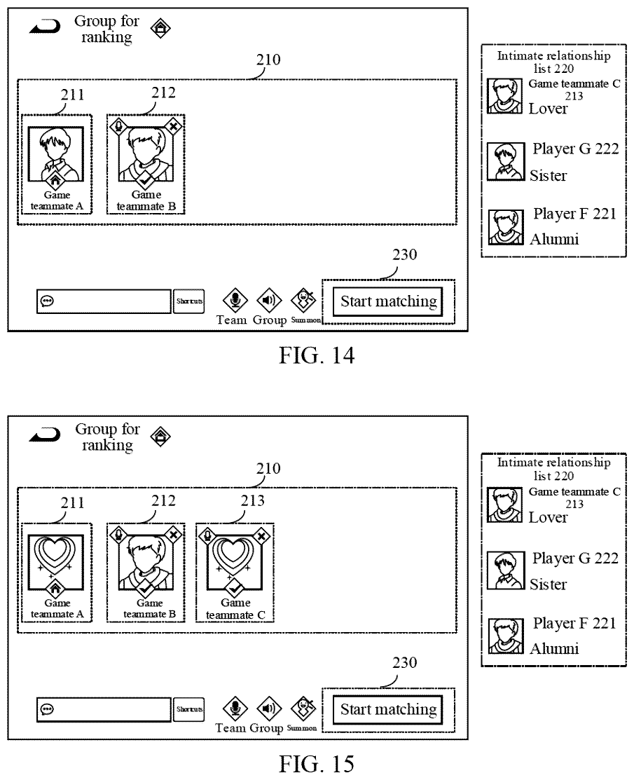

A game process includes at least one of the following: a member matching process, a waiting-for-start process, a game battle process, or a game settlement process. In the member matching process, a quantity of game teammates in a game team is insufficient, and a game teammate may join or leave the game team. For example, FIG. 14 is a schematic diagram of an intimate relationship-based avatar processing method according to an embodiment of this disclosure. A game team 210 includes a game teammate A 211 and a game teammate B 212.

Operation 1320: The server stores a new teammate ID in a list M.

The server stores a teammate ID of a new game teammate who subsequently joins the game team in the list M. For example, FIG. 15 is a schematic diagram of an intimate relationship-based avatar processing method according to an embodiment of this disclosure. An ID of a new teammate who subsequently joins the game team is a game teammate C 213. The server stores the game teammate C 213 in the list M.

Operation 1330: The server stores object IDs in an intimate relationship list of other game teammates than the new game teammate in a list N.

The server stores the object IDs in the intimate relationship list of other game teammates than the new game teammate in the game team in the list N, and retains non-repeated object IDs. The intimate relationship includes a plurality of types. For example, the intimate relationship includes at least one of the following: a lover relationship, a sisterhood relationship, a brotherhood relationship, a close friend relationship, a former teammate relationship, an alumni relationship, or a colleague relationship. As shown in FIG. 15, object IDs in an intimate relationship list of a game teammate A 211 include: the game teammate C 213 whose intimate relationship is a lover relationship, a player G 222 whose intimate relationship is a sisterhood relationship, and a player F 221 whose intimate relationship is an alumni relationship. There is no object having an intimate relationship with the game teammate B 212. The server stores the foregoing object IDs in the list N.

Operation 1340: The server determines whether there is the same ID among the new teammate ID and the object IDs.

The server compares the new teammate ID with all of the object IDs to determine whether there is the same ID. If there is no same ID, operation 1350 is performed. If there is the same ID, operation 1352 is performed.

Operation 1350: The terminal keeps a display state of a teammate avatar unchanged.

In a case that there is no same ID, the terminal does not perform processing on the display state of the teammate avatar, and keeps the display state of the teammate avatar unchanged.

Operation 1352: The server stores the new teammate ID and a teammate ID having a corresponding intimate relationship as well as the corresponding intimate relationship in a list P, and marks the new teammate ID and the teammate ID having the corresponding intimate relationship.

For example, as shown in FIG. 15, the game teammate C 213 in the game team has the same ID as that of the game teammate C 213 in the intimate relationship list of the game teammate A 211. The server stores the game teammate A 211 and the game teammate C 213 as well as the intimate relationship between the game teammate A 211 and the game teammate C 213 being the lover relationship in the list P, and marks the game teammate A 211 and the game teammate C 213.

Operation 1360: The server determines whether a quantity of times that the new teammate ID is marked is greater than 1.

Because the new teammate ID is marked only when being the same as the object IDs, the quantity of times that the new teammate ID is marked is 1 in a case that there is one intimate relationship. The quantity of times that the new teammate ID is marked is greater than 1 in a case that there is a plurality of intimate relationships. In a case that the quantity of times that the new teammate ID is marked is equal to 1, operation 1370 is performed. In a case that the quantity of times that the new teammate ID is marked is greater than 1, operation 1372 is performed.

Implementation principles of operation 1370 to operation 13120 are the same as those of operation 1070 to operation 10120, which are not described herein again.

Operation 13130: The terminal changes a display state of a teammate avatar based on the corresponding intimate relationship.

The terminal replaces, based on the corresponding intimate relationship, the teammate avatars with intimacy avatars corresponding to different intimate relationships for display. For example, as shown in FIG. 15, the intimate relationship between the game teammate A 211 and the game teammate C 213 is the lover relationship. In this case, the terminal replaces avatars of the game teammate A 211 and the game teammate C 213 with heart intimacy avatars representing the lover relationship for display.

In some embodiments, the terminal replaces the teammate avatars with a same type of intimacy avatars for display. For example, as shown in FIG. 15, in a case that the intimate relationship between the game teammate A 211 and the game teammate C 213 is the lover relationship, the terminal replaces the avatars of the game teammate A 211 and the game teammate C 213 with the heart intimacy avatars representing the lover relationship for display.

Alternatively, the terminal replaces the teammate avatars with a plurality of intimacy avatars for display. For example, in a case that an intimate relationship between the game teammate A 211 and the game teammate B 212 is a sisterhood relationship and the intimate relationship between the game teammate A 211 and the game teammate C 213 is the lover relationship, the terminal replaces the avatar of the game teammate A 211 with the heart intimacy avatar representing the lover relationship and with a bunny-ear intimacy avatar representing the sisterhood relationship for display, replaces the avatar of the game teammate B 212 with the bunny-ear intimacy avatar representing the sisterhood relationship for display, and replaces the avatar of the game teammate C 213 with the heart intimacy avatar representing the lover relationship for display.

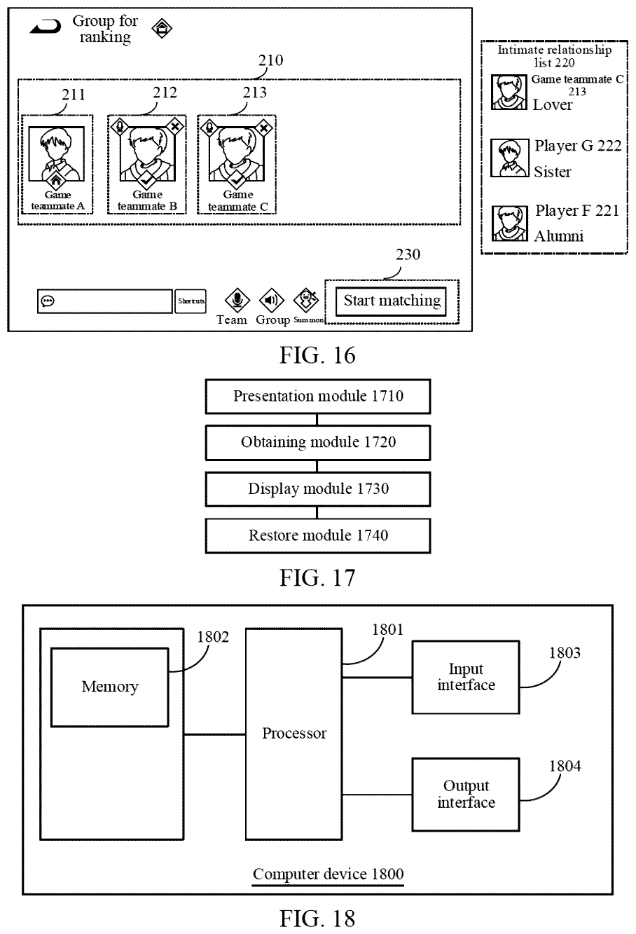

In some embodiments, after display duration of the intimacy avatars reaches a duration threshold, the terminal restores the intimacy avatars as the teammate avatars for display. For example, FIG. 16 is a schematic diagram of an intimate relationship-based avatar processing method according to an embodiment of this disclosure. The duration threshold is two seconds. After the intimacy avatars are displayed for two seconds, the terminal restores the intimacy avatars as the teammate avatars for display.

Alternatively, the intimacy avatars continue to be displayed until the member matching process ends. For example, duration of the member matching process is 30 seconds, during which the intimacy avatars continue to be displayed and do not disappear.

In conclusion, according to the method provided in this embodiment, in a member matching process, a new teammate ID is compared with object IDs in an intimate relationship list of other game teammates, to determine a game teammate having an intimate relationship with the new game teammate and display intimacy avatar information corresponding to the intimate relationship. In this way, an intimate relationship between game teammates can be represented without additional communication, so that a game teammate not in the intimate relationship can know information about a game team. In this way, regions other than teammate avatars are not occupied, so that display space can be saved, and a probability of an intimate relationship between game teammates being ignored by another game teammate can be reduced.

In addition, according to the method provided in this embodiment, intimacy avatar information corresponding to different intimate relationships is displayed based on a display priority and an intimacy level, to represent a corresponding intimate relationship between the new game teammate and another game teammate, so that a probability of an intimate relationship between game teammates and being ignored by another game teammate can be reduced.

In addition, according to the method provided in this embodiment, display duration of the intimacy avatar information is limited, to reduce power consumption of the terminal while representing the intimate relationship between the game teammates.

In addition, according to the method provided in this embodiment, the display duration of the intimacy avatar information is not limited, so that a game teammate not in the intimate relationship can know the intimate relationship between the game teammates at any time, thereby reducing a probability of an intimate relationship between game teammates being ignored by another game teammate.

FIG. 17 is a block diagram of an intimate relationship-based avatar processing apparatus according to an embodiment of this disclosure. The apparatus includes:
a presentation module 1710, configured to perform operation 310 in the embodiment in FIG. 3;
an obtaining module 1720, configured to perform operation 320 in the embodiment in FIG. 3; and
a display module 1730, configured to perform operation 330 in the embodiment in FIG. 3.

In a design, the display module 1730 is configured to perform operation 331 in the embodiment in FIG. 4; or
configured to perform operation 332 in the embodiment in FIG. 5.

An intimate relationship includes at least two types, and different intimate relationships correspond to different intimacy avatar information.

The intimacy avatar information includes at least one of the following: a first intimacy avatar and/or a first intimacy avatar frame corresponding to a lover relationship; a second intimacy avatar and/or a second intimacy avatar frame corresponding to a sisterhood relationship; a third intimacy avatar and/or a third intimacy avatar frame corresponding to a brotherhood relationship; a fourth intimacy avatar and/or a fourth intimacy avatar frame corresponding to a close friend relationship; a fifth intimacy avatar and/or a fifth intimacy avatar frame corresponding to a former teammate relationship; a sixth intimacy avatar and/or a sixth intimacy avatar frame corresponding to an alumni relationship; or a seventh intimacy avatar and/or a seventh intimacy avatar frame corresponding to a colleague relationship.

In a design, a restore module 1740 is configured to perform operation 340 in the embodiment in FIG. 6. A duration threshold is a fixed value, or the duration threshold is positively correlated with an intimacy level of the intimate relationship.

In a design, the display module 1730 is configured to perform operation 333 in the embodiment in FIG. 7; or configured to perform operation 334 in the embodiment in FIG. 8. A first intimate relationship is an intimate relationship with a high display priority in the at least two intimate relationships, a second game teammate and a first game teammate have the first intimate relationship, and a corresponding intimate relationship is an intimate relationship between a first game teammate and another game teammate.

In a design, the intimate relationship is established by the game teammates before a current battle.

In a design, the intimate relationship is identified by a server based on personalized information of the game teammates.

In a design, the intimate relationship is identified by the server in at least one of the following manners under authorization for information use:
obtaining a game dialog record between the game teammates, and identifying an appellation keyword from the game dialog record; and identifying the intimate relationship between the game teammates based on the appellation keyword;
obtaining personal attribute information of the game teammates, and identifying same experience information from the personal attribute information; and identifying the intimate relationship between the game teammates based on the same experience information; or
obtaining current geographical location information of the game teammates, and identifying a same enterprise and institution location from the geographical location information; and identifying the intimate relationship between the game teammates based on the same enterprise and institution location.

In a design, the display module 1730 is configured to perform operation 335 in the embodiment in FIG. 8.

In a design, the presentation module 1710 is configured to display a team presentation interface of a game team in a member matching process of a current battle; or configured to display a team presentation interface of a game team in a waiting-for-start process of a current battle.

FIG. 18 is a schematic diagram of a structure of a computer device 1800 according to an embodiment of this disclosure. The computer device 1800 includes a processor 1801 (e.g., processing circuitry) and a memory 1802 (e.g., a non-transitory computer-readable storage medium).

The processor 1801 may include one or more processing cores, for example, a 4-core processor or an 8-core processor. The processor 1801 may be implemented in at least one hardware form of a digital signal processor (DSP), a field-programmable gate array (FPGA), or a programmable logic array (PLA). The processor 1801 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

The memory 1802 may include one or more computer-readable storage media. The computer-readable storage medium may be non-transitory. The memory 1802 may further include a high-speed random access memory and a non-volatile memory, for example, one or more disk storage devices or flash storage devices. In some embodiments, the non-transitory computer-readable storage medium in the memory 1802 is configured to store at least one instruction, and the at least one instruction is configured for being executed by the processor 1801 to implement the intimate relationship-based avatar processing method provided in the method embodiments of this disclosure. In some embodiments, the server 1800 may alternatively include an input interface 1803 and an output interface 1804. The processor 1801, the memory 1802, the input interface 1803, and the output interface 1804 may be connected by a bus or a signal cable. Each peripheral device may be connected to the input interface 1803 and the output interface 1804 by a bus, a signal cable, or a circuit board. The input interface 1803 and the output interface 1804 may be configured to connect at least one peripheral device related to input/output (I/O) to the processor 1801 and the memory 1802. In some embodiments, the processor 1801, the memory 1802, the input interface 1803, and the output interface 1804 are integrated on the same chip or circuit board. In some other embodiments, any one or two of the processor 1801, the memory 1802, the input interface 1803, and the output interface 1804 may be implemented on a single chip or circuit board, which is not limited in embodiments of this disclosure.

A person skilled in the art may understand that the structure shown above constitutes no limitation on the server 1800, and the server 1800 may include more or fewer components than those shown in the figure, or some components may be combined, or a different component deployment may be used.

In an embodiment, a computer program product is further provided. The computer program product includes computer instructions stored in a computer-readable storage medium such as a non-transitory computer-readable storage medium. A processor of a computer device reads the computer instructions from the computer-readable storage medium. The processor reads the computer instructions from the computer-readable storage medium and executes the computer instructions to implement the intimate relationship-based avatar processing method provided in the foregoing method embodiments. In an embodiment, a computer-readable storage medium is further provided. The computer-readable storage medium has a computer program stored thereon, and the computer program is loaded and executed by a processor to implement the intimate relationship-based avatar processing method provided in the foregoing method embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A person of ordinary skill in the art may understand that all or some of the operations of the foregoing embodiments may be implemented by hardware or a program instructing relevant hardware. The program may be stored in a computer-readable storage medium. The foregoing storage medium may be a read-only memory, a magnetic disk, an optical disc, or the like. A person skilled in the art may be aware that in the foregoing one or more examples, functions described in embodiments of this disclosure may be implemented by hardware, software, firmware, or any combination thereof. When implemented by using software, the functions can be stored in a computer-readable medium or can be used as one or more instructions or code in a computer-readable medium for transferring. The computer-readable medium includes a computer storage medium and a communication medium. The communication medium includes any medium that enables a computer program to be transmitted from one place to another. The storage medium may be any available medium accessible to a general-purpose or dedicated computer.

What is claimed is:

1. A method for displaying relationship-based relationship indicators in a gaming interface, the method comprising:
displaying a team interface including a plurality of player positions;
displaying player avatars at the plurality of player positions, each player avatar corresponding to a respective team member of a plurality of team members; and
when a relationship is detected between at least two team members of the plurality of team members, displaying relationship indicators at the plurality of player positions corresponding to the at least two team members, wherein the relationship indicators indicate the relationship detected between the at least two team members.

2. The method according to claim 1, wherein the displaying the relationship indicators comprises one of:
replacing the player avatars with the relationship indicators at the plurality of player positions corresponding to the at least two team members; or
overlaying the relationship indicators on top of the player avatars at the plurality of player positions corresponding to the at least two team members.

3. The method according to claim 2, wherein the relationship is selected from a plurality of relationship types, and each relationship type of the plurality of relationship types corresponds to a distinct relationship indicator.

4. The method according to claim 1, wherein the relationship indicators comprise at least one of:
a heart indicating a romantic relationship;
bunny ears indicating a sisterhood relationship;
a profile of a virtual object indicating a brotherhood relationship;
an arm-wrestling graphic indicating a close friendship;
a dual warrior graphic indicating a former teammate relationship;
a book indicating an alumni relationship; or
a briefcase indicating a colleague relationship.

5. The method according to claim 1, further comprising:
displaying the relationship indicators for a display duration;
after the display duration reaches a duration threshold,
cancelling the display of the relationship indicators; and
displaying the player avatars, wherein
the duration threshold is based on a relationship level between the at least two team members.

6. The method according to claim 1, wherein the displaying the relationship indicators comprises:
when a first team member of the plurality of team members has multiple relationships, displaying the relationship indicator corresponding to a highest priority relationship of the multiple relationships at the plurality of player positions of both the first team member and a second team member of the plurality of team members sharing the highest priority relationship.

7. The method according to claim 1, wherein the displaying the relationship indicators comprises:
when a first team member has multiple relationships, simultaneously displaying multiple relationship indicators at the plurality of player positions of the first team member while displaying corresponding single relationship indicators at the plurality of player positions of the plurality of team members sharing respective relationships of the multiple relationships with the first team member.

8. The method according to claim 1, wherein the displaying the relationship indicators comprises:
sequentially displaying multiple relationship indicators at a player position of the plurality of player positions corresponding to a first team member of the plurality of team members having multiple relationships; and
for each relationship indicator of the multiple relationship indicators, synchronously displaying the respective relationship indicator at the plurality of player positions corresponding to both the first team member and second team members of the plurality of team members sharing the respective relationship corresponding to the respective relationship indicator.

9. The method according to claim 1, wherein the team interface is displayed before a start of a game.

10. The method according to claim 1, wherein the relationship is established by the at least two team members prior to entering the team interface, or automatically determined based on analysis of player profile data of the at least two team members.

11. The method according to claim 10, wherein the automatically determining the relationship comprises at least one of:
analyzing chat logs between the at least two team members to identify relationship keywords;
comparing player profile information of the at least two team members to identify a shared experience; or
analyzing current location data to identify the at least two team members at a same location.

12. The method according to claim 1, wherein the relationship corresponds to a relationship level, and the displaying the relationship indicators includes displaying visual effects based on the relationship level, the visual effects including at least one of:
displaying a first stage relationship symbol when the relationship level reaches a first threshold; and
displaying a second stage relationship symbol when the relationship level reaches a second threshold higher than the first threshold.

13. The method according to claim 1, wherein the displaying the relationship indicators includes displaying visual connections between the relationship indicators at the plurality of player positions corresponding to the at least two team members sharing the relationship.

14. An apparatus, comprising:
processing circuitry configured to:
display a team interface including a plurality of player positions;
display player avatars at the plurality of player positions, each player avatar corresponding to a respective team member of a plurality of team members; and
when a relationship is detected between at least two team members of the plurality of team members, display relationship indicators at the plurality of player positions corresponding to the at least two team members, wherein the relationship indicators indicate the relationship detected between the at least two team members.

15. The apparatus according to claim 14, wherein the processing circuitry is configured to:
replace the player avatars with the relationship indicators at the plurality of player positions corresponding to the at least two team members; or
overlay the relationship indicators on top of the player avatars at the plurality of player positions corresponding to the at least two team members.

16. The apparatus according to claim 15, wherein the relationship is selected from a plurality of relationship types, and each relationship type of the plurality of relationship types corresponds to a distinct relationship indicator.

17. The apparatus according to claim 14, wherein the relationship indicators comprise at least one of:
a heart indicating a romantic relationship;
bunny ears indicating a sisterhood relationship;
a profile of a virtual object indicating a brotherhood relationship;
an arm-wrestling graphic indicating a close friendship;
a dual warrior graphic indicating a former teammate relationship;
a book indicating an alumni relationship; or
a briefcase indicating a colleague relationship.

18. The apparatus according to claim 14, wherein the processing circuitry is configured to:
display the relationship indicators for a display duration;
after the display duration reaches a duration threshold,
cancel the display of the relationship indicators; and
display the player avatars, wherein
the duration threshold is based on a relationship level between the at least two team members.

19. The apparatus according to claim 14, wherein the processing circuitry is configured to:
when a first team member of the plurality of team members has multiple relationships, display the relationship indicator corresponding to a highest priority relationship of the multiple relationships at the plurality of player positions of both the first team member and a second team member of the plurality of team members sharing the highest priority relationship.

20. A non-transitory computer-readable storage medium, storing instructions which when executed by a processor cause the processor to perform:
displaying a team interface including a plurality of player positions;
displaying player avatars at the plurality of player positions, each player avatar corresponding to a respective team member of a plurality of team members; and
when a relationship is detected between at least two team members of the plurality of team members, displaying relationship indicators at the plurality of player positions corresponding to the at least two team members, wherein the relationship indicators indicate the relationship detected between the at least two team members.
